(19) United States
(12) Patent Application Publication
(10) Pub. No.: US 2005/0007086 A1
(43) Pub. Date: Jan. 13, 2005

(54) Switching regulator control circuit

(76) Inventor: Shigeyuki Morimoto, Chiba-shi (JP)

Correspondence Address: ADAMS & WILKS, 31st Floor, 50 Broadway, New York, NY, 10004, US

(21) Appl. No.: 10/888,661

(22) Filed: Jul. 9, 2004

(30) Foreign Application Priority Data
Jul. 10, 2003 (JP) 2003-194729

(51) Int. Cl. G05F 1/40

(52) U.S. Cl. 323/282

(57) ABSTRACT

The present invention provides an SW regulator control circuit that is efficient in both of the cases where the load is heavy and where the load is light. Two switch MOS transistors are disposed as switching elements of the SW regulator in parallel which are large in an on-resistance and small in a gate capacity, and in the case where a load of the SW regulator is heavy, the two switch MOS transistors are driven in parallel to lessen the on-resistance whereas in the case where the load is light, one of the two switch MOS transistors is driven to lessen the gate capacity.

### BACKGROUND OF THE INVENTION

1. Field of the Invention

The present invention relates to a switching regulator (hereinafter referred to as “SW regulator”) which is capable of improving simultaneously the efficiencies in both of the cases where a load is heavy and where the load is light.

2. Description of the Related Art

A conventional SW regulator control circuit includes, as shown in FIG. 2, a reference voltage 18, dividing resistors 16, 17, an error amplifier 19, an oscillating circuit 20, a pulse frequency modulation control circuit (hereinafter referred to as “PFM control circuit”) 21, a pulse width modulation control circuit (hereinafter referred to as “PWM control circuit) 22, a switch driving circuit 23, and a switch MOS transistor 11.

Assuming that an output voltage of the error amplifier 19 is Verr, an output voltage of the reference voltage 18 is Vref, and a voltage at a node between the dividing resistor 16 and the dividing resistor 17 is Va, if Vref>Va, Verr rises whereas if Vref<Va, Verr is decreased.

The PFM control circuit 21 and the PWM control circuit 22 compare Verr with the output of the oscillating circuit 20, a chopping wave for example, and outputs a signal. When Verr decreases or increases, any one of the PFM control circuit 21 and the PWM control circuit 22 is used to conduct the on/off control on the switch MOS transistor 11 through the switch driving circuit 23.

For example, when the load increases, that is, when an output load current value increases, the output voltage Vout of the SW regulator steps down, and therefore Verr becomes higher. At this time, the PWM control circuit 22 performs the control such that the pulse width is made larger to keep the output voltage Vout.

Also, when the load decreases, that is, when an output load current value decreases, Vout steps up, and therefore Verr becomes lower. At this time, the PFM control circuit 21 performs the control such that the pulse width remains constant and the pulse frequency is made lower to keep the output voltage Vout.

On the other hand, the prominent characteristics pertaining to the efficiency in the SW regulator is the on-resistance and the gate capacity of the switch MOS transistor 11. In the efficiency of the SW regulator, in the case where the load is heavy, the loss of the on-resistance is dominant whereas in the case where the load is light, the switching loss that is attributable to the gate capacity is dominant. In order to improve the efficiency of the SW regulator, it is necessary to lessen both of the on-resistance and the gate capacity of the switch MOS transistor 11.

However, the on-resistance and the gate capacity of the switch MOS transistor 11 have a relationship of trade-off. That is, for example, when the efficiency in the case where the load is heavy is emphasized, there arises a problem in that the efficiency of the SW regulator is considerably deteriorated in a range of the PFM control operation when the load is light (for example, refer to JP 2002-320379 B).

### SUMMARY OF THE INVENTION

The present invention has been made to solve the above problem, and it is an object of the present invention to provide an SW regulator that is efficient in both of the cases where the load is heavy and where the load is light.

The present invention solves the above problem with the following structure. The switching element of the SW regulator includes two switch MOS transistors disposed in parallel which are large in the on-resistance and small in the gate capacity, and in the case where the load of the SW regulator is heavy, the two switch MOS transistors are driven in parallel to lessen the on-resistance whereas in the case where the load is light, one of the two switch MOS transistors is driven to lessen the gate capacity.

### BRIEF DESCRIPTION OF THE DRAWINGS

In the accompanying drawings:

FIG. 1 is a circuit diagram showing an SW regulator control circuit according to the present invention; and

FIG. 2 is a circuit diagram showing a conventional SW regulator control circuit.

### DESCRIPTION OF THE PREFERRED EMBODIMENT

Hereinafter, an embodiment of the present invention will be described with reference to the drawings.

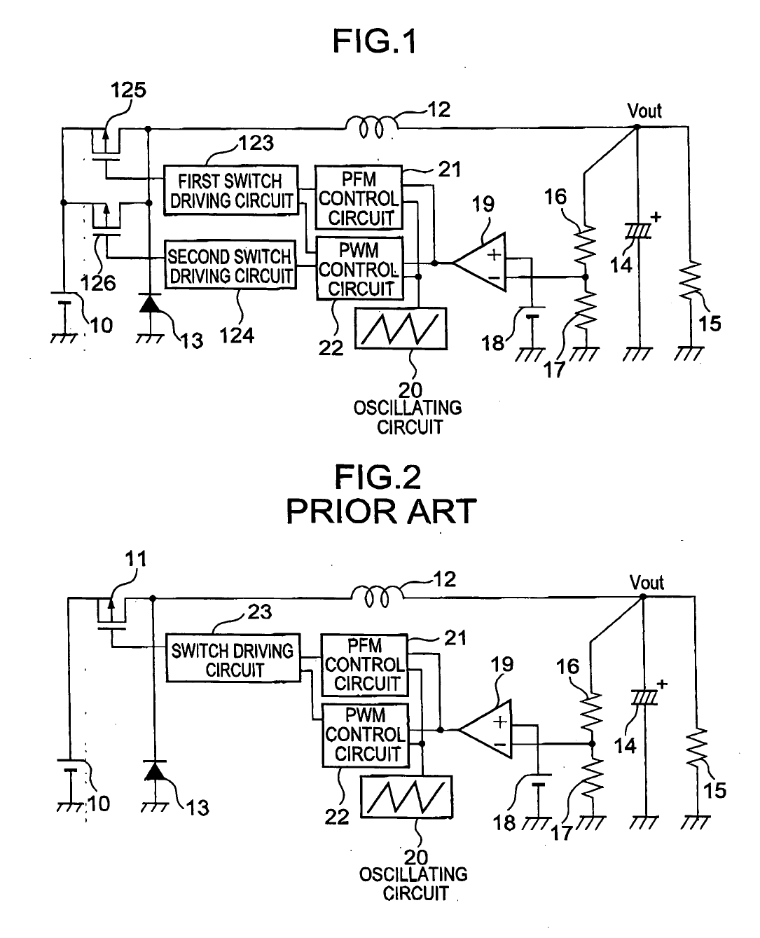

FIG. 1 is a diagram showing an SW regulator control circuit according to the present invention. A reference voltage 18, a dividing resistor 16, a dividing resistor 17, an error amplifier 19, an oscillating circuit 20, a PFM control circuit 21, and a PWM control circuit 22 are identical with those in the conventional SW regulator. The switch of the SW regulator is characterized in that two transistors, a first switch MOS transistor 124 and a second switch MOS transistor 126, which are large in the on-resistance and small in the gate capacity, are disposed in parallel.

In the case where the load is light, the PFM control circuit 21 performs the control such that a pulse width remains constant and a pulse frequency is lowered to keep an output voltage Vout. In this situation, a first switch driving circuit 123 controls the first switch MOS transistor 125 according to the pulse of the PFM control circuit 21, and the second switch driving circuit 124 and the second switch MOS transistor 126 stop. In the efficiency in the case where the load is light, though the scale of the switching loss that is attributable to the gate capacity is dominant, the switch MOS transistor that is relatively small in the gate capacity is advantageously used.

In the case where the load is heavy, the PWM control circuit 22 performs the control such that the pulse width is made larger to keep the output voltage Vout. In this situation, the first switch driving circuit 123 and the second switch driving circuit 124 control the first switch MOS transistor 125 and the second switch MOS transistor 126 according to the pulse of the PWM control circuit 22. In the efficiency in the case where the load is heavy, the loss that is attributable to the on-resistance is dominant, but the on-resistance can be advantageously lessened by driving the two switch MOS transistors in parallel.

With the above circuit structure, it is possible to improve simultaneously the efficiencies both in both of the cases where the load is heavy and where the load is light.

Also, the embodiment of the present invention is described with reference to a step-down SW regulator circuit, however the same advantages are obtained even if the present invention is applied to a step-up switching regulator circuit and a reverse switching regulator circuit.

As described above, the SW regulator according to the present invention has such an advantage that the efficiencies in both of the cases where the load is heavy and where the load is light are improved simultaneously.

1. A switching regulator control circuit, comprising:
a switching element that is electrically connected between a power supply and an output terminal;
a reference voltage source that generates a reference voltage;
an oscillating circuit;
an error amplifier that outputs a difference between a voltage which derives from dividing an output voltage of the output terminal and the reference voltage;
a PWM control circuit that compares an output of the error amplifier with an output of the oscillating circuit, modulates a pulse width and outputs a control signal;
a PFM control circuit that compares an output of the error amplifier with an output of the oscillating circuit, modulates a pulse frequency and outputs a control signal; and
a switch driving circuit that controls the switching element upon receiving the outputs of the PWM control circuit and the PFM control circuit,
wherein when the switching element is controlled according to the output of the PWM control circuit, an on-resistance of the switching element is lessened.

2. A switching regulator control circuit according to claim 1,
wherein the switching element comprises a MOS transistor,
wherein when the MOS transistor is controlled according to the output of the PFM control circuit, a gate capacity of the MOS transistor is lessened, and
wherein when the MOS transistor is controlled according to the output of the PWM control circuit, the on-resistance of the MOS transistor is lessened.

3. A switching regulator control circuit according to claim 2,
wherein the switching element comprises a plurality of MOS transistors that are connected in parallel with each other,
wherein only one of the MOS transistors is driven when the MOS transistor is controlled according to the output of the PFM control circuit, and
wherein the plurality of MOS transistors are driven in parallel with each other when the MOS transistor is controlled according to the output of the PWM control circuit.
